(19) United States
(12) Patent Application Publication
(10) Pub. No.: US 2025/0291490 A1
(43) Pub. Date: Sep. 18, 2025

(54) ENHANCING READ PERFORMANCE OF A STORAGE DEVICE IN A MULTI-APPLICATION ENVIRONMENT

(71) Applicant: SanDisk Technologies LLC, AUSTIN, TX (US)

(72) Inventors: AMIT SHARMA, BENGALURU (IN); Dinesh Kumar Agarwal, Bangalore (IN); Abhinandan Venugopal, BENGALURU (IN)

(73) Assignee: SanDisk Technologies LLC, AUSTIN, TX (US)

(21) Appl. No.: 18/603,161

(22) Filed: Mar. 12, 2024

(51) Int. Cl. G06F 3/06

(52) U.S. Cl. CPC G06F 3/0613; G06F 3/0659; G06F 3/0679

(57) ABSTRACT

A storage device minimizes localization of random read sensitive application data (RRSAD) on a memory device. The storage device includes a memory device including parallel sense units and a random-access memory to store data received from hosts. A controller on the storage device may receive the data from the hosts and caches the data in the random-access memory. The controller identifies RRSAD in the cached data and arranges a storage order of the data. The controller also programs the RRSAD across the parallel sense units on the memory device according to an arranged storage order.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks that may be grouped together into a plane. A memory die may include a single plane full of data blocks or multiple planes that have been linked together. Physical blocks from multiple dies may also be configured to form a meta block. i.e., a logical block which may be composed of physical blocks from all the dies and channels in the memory device to extract higher throughput for parallel reads and writes.

The storage device may operate in a multi-host/multi-user environment, wherein multiple virtual machines or multiple host applications may access the storage device. The multiple users of the storage device are generally referred to herein as the host(s). Each host may write data on the memory device and subsequently read the data from the memory device. When the hosts send data to the storage device for the data to be written to the memory device, the storage device may write the data to an open meta block on the memory device. Each open meta block may have a programming size that the storage device may want to program at a time to optimize programming time. For example, if the open meta block is a single-level cell (SLC) block, the storage device may want to write one full SLC page at a time, and if the open block is a triple-level cell (TLC) block, the storage device may want to write three times the SLC data. When the storage device receives data from the hosts, the storage device may cache the data in an internal random-access memory (RAM) until the storage device accumulates sufficient data to program the appropriate amount on the open meta block. Once the storage device has accumulated the appropriate amount of data from the hosts, the storage device may write the data on the open meta block.

One or more hosts may send data to the storage device in random workloads. Random workloads include individual chunks of data that the host may write to the memory device and retrieve from the storage device in a random order. For example, if a host is a laptop, the host may send small chucks of data, for example, four kilobytes (KB) chunks, representing data from applications running on the laptop. The host may thereafter retrieve the data in any order, wherein the order may depend on the files requested by a user of the laptop. On the other hand, if a host is storing, for example, a large video file, the host may write individual chunks of data including the video file and retrieve the video file chunks sequentially. If the storage device is writing to an open TLC meta block having, for example, a thirty-two KB logical page, as the storage device may store three bits per cell, the storage device may store ninety-six KB per page. Using the example, where one or more of the hosts may send four KB commands, until the storage device has twenty-four chucks of data (i.e. 96 KB/4 KB), the storage device may cache the data received from the hosts in the RAM. When the storage device has accumulated twenty-four chucks of data, the storage device may write the data to the open TLC meta block in the order received.

In a multi-host environment, depending on how the data from various hosts are received and interleaved by the storage device, the random data from a host may be localized to one or more dies (i.e., the data from one host may be programmed on one or more dies in the meta block, rather than being programmed across all dies in the meta block). Localization of data in a meta block may cause an issue during random reads when the host sends requests for random read sensitive application data (RRSAD) to the storage device. RRSAD may be data from different logical block address ranges that are non-contiguous. For example, RRSAD may be the data associated with various applications sent from a laptop. In performing random read operations, the storage device may sense/read each die in a meta block in parallel for the storage device to achieve its random read benchmarks and provide a high number of random read input/output operations per second. So, for example, if a meta block includes eight dies, to reach its peak random read performance, the storage device should be reading from all eight of the dies in parallel. If the RRSAD from one host is localized to, for example, two dies in the meta block, even if there are eight pending read commands for the data stored on the two dies in the meta block, the storage device may only execute two read commands in parallel as the storage device may only perform one read operation at a time on a die. An apparatus and/or method is thus needed to minimize localization of RRSAD from a host on a meta block to enhance the random read performance of the storage device in a multi-host environment.

### SUMMARY OF THE INVENTION

In some implementations, the storage device may minimize localization of random read sensitive application data (RRSAD) on a memory device. The storage device includes a memory device including parallel sense units and a random-access memory to store data received from hosts. When a controller on the storage device receives the data from the hosts, the controller caches the data and identifies RRSAD received from a first host in the cached data. The controller arranges a storage order of the data and programs the RRSAD across the parallel sense units on the memory device according to an arranged storage order.

In some implementations, a method is provided on a storage device for minimizing localization of random read sensitive application data (RRSAD) on a memory device. The method includes receiving data from the hosts and caching the data in a random-access memory. The method also includes identifying RRSAD received from a first host in the cached data. The method further includes arranging a storage order of the data and programming the RRSAD across parallel sense units on a memory device according to an arranged storage order.

In some implementations, a storage device may minimize localization of random read sensitive application data (RRSAD) on a memory device. The storage device includes a memory device including parallel sense units and a random-access memory to store data received from a host. The controller provides a parallel sense capability of the memory device to the host. When the controller receives the data from the host formed according to the parallel sense capability of the memory device, the controller programs the RRSAD across the parallel sense units on the memory device according to an order received from the host.

### BRIEF DESCRIPTION OF THE DRAWINGS

FIG. 1 is a schematic block diagram of an example system in accordance with some implementations.

FIG. 2 is a block diagram showing an arrangement of pending write commands being programmed on an open meta block based on a Random-Read-Sensitive-Application Data (RRSAD) hint sent from a host in accordance with some implementations.

FIG. 3 is another block diagram showing an arrangement of pending write commands based on a RRSAD hint from a host in accordance with some implementations.

FIG. 4 is a block diagram showing an arrangement of pending write commands based on RRSAD hints from multiple hosts in accordance with some implementations.

FIG. 5 is a block diagram showing an arrangement of write commands at a host to ensure that RRSAD is spread across parallel sense units in accordance with some implementations.

FIG. 6 is a flow diagram of an example process for rearranging pending write commands being programmed on an open meta block based on RRSAD hints sent from one or more hosts in accordance with some implementations.

FIG. 7 is another flow diagram of an example process for rearranging pending write commands based on a RRSAD hint from a host in accordance with some implementations.

FIG. 8 is a flow diagram of an example process for rearranging write commands at a host to ensure that RRSAD is spread across parallel sense units in accordance with some implementations.

FIG. 9 is a diagram of an example environment in which systems and/or methods described herein are implemented.

FIG. 10 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

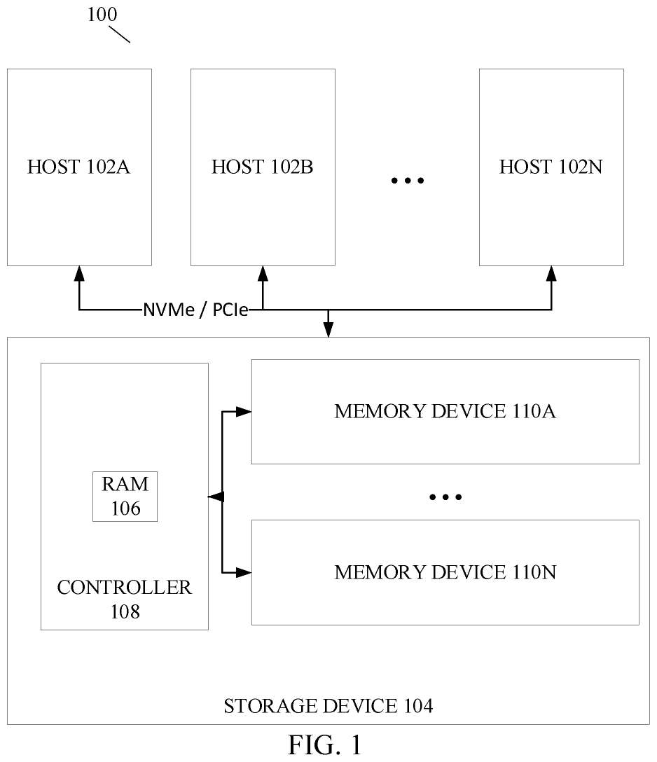

FIG. 1 is a schematic block diagram of an example system in accordance with some implementations. System 100 includes hosts 102a-102n (referred to herein as host(s) 102) and a storage device 104. Hosts 102 may be multiple virtual machines or multiple host applications that may access the storage device 104 at the same time. Host 102 and storage device 104 may be in the same physical location as components on a single computing device or on different computing devices that are communicatively coupled. Storage device 104, in various embodiments, may be disposed in one or more different locations relative to the host 102. System 100 may include additional components (not shown in this figure for the sake of simplicity).

Storage device 104 may include a random-access memory (RAM) 106, a controller 108, and one or more non-volatile memory devices 110a-110n (referred to herein as the memory device(s) 110). Storage device 104 may be, for example, a solid-state drive (SSD), and the like. RAM 106 may be temporary storage such as a dynamic RAM (DRAM) that may be used to cache information in storage device 104.

Controller 108 may interface with host 102 and process foreground operations including instructions transmitted from host 102. For example, controller 108 may read data from and/or write to memory device 110 based on instructions received from host 102. Controller 108 may further execute background operations to manage resources on memory device 110. For example, controller 108 may monitor memory device 110 and may execute garbage collection and other relocation functions per internal relocation algorithms to refresh and/or relocate the data on memory device 110.

Memory device 110 may be flash based. For example, memory device 110 may be a NAND flash memory that may be used for storing host and control data over the operational life of memory device 110. Memory device 110 may be included in storage device 104 or may be otherwise communicatively coupled to storage device 104. Memory device 110 may be divided into blocks and data may be stored in the blocks in various formats, with the formats being defined by the number of bits that may be stored per memory cell. For example, a single-level cell (SLC) format may write one bit of information per memory cell, a multi-level cell (MLC) format may write two bits of information per memory cell, a triple-level cell (TLC) format may write three bits of information per memory cell, and a quadruple-level cell (QLC) format may write four bits of information per memory cell, and so on. The blocks in memory device 110 may be hybrid blocks, wherein the blocks may be programmed in multiple formats. For example, a block may be initially programmed as an SLC block and later programmed as a TLC block. Formats storing fewer bits in each cell are more easily accessed, durable, and less error-prone than formats storing more bits per cell. However, formats storing fewer bits in each cell are also more expensive.

Blocks in memory device 110 may be grouped together into a plane, and a die may include a single plane full of data blocks or multiple planes that have been linked together. The number and configurations of planes within a flash die may be adaptable. Some memory devices 110 may include an asynchronous independent plane read (ASIR) feature, wherein each plane may be read independently and may be an independent sense/read unit. If, for example, a memory device 110 with the ASIR feature has four planes per die, each plane in a die may be read independently, and as such, the memory device 110 may have four parallel independent sense units per die. Each die may also be independently written to or read and may also be an independent sense unit. Accordingly, the parallel read capability on memory device 110 may be at the die level and/or the plane level. A meta block on the memory device may be formed in an interleaved manner, wherein the meta block may include a block from each plane in a die.

To minimize localization of Random-Read-Sensitive-Application Data (RRSAD) received from each host 102 in one or more independent sense units when storage device 104 writes the host data to memory device 110, controller 108 may identify which data received from one or more hosts 102 is RRSAD. Taking into consideration the parallel sense units (for example, dies and/or AIPR planes) on memory device 110, controller 108 may program RSSAD data from each host 102 in a manner to ensure that the RRSAD from each host 102 may be spread across the parallel sense units on memory device 110. When controller 108 receives data including RSSAD data and non-RSSAD data from multiple hosts 102 for programming on memory device 104, controller 108 may cache the data in RAM 106 in the order received. When controller 108 accumulates sufficient data in RAM 106 to program an open meta block, rather than storing the data in the parallel sense units using on the order in which the data was received by storage device 104, controller 108 may arrange the RRSAD stored in RAM 106 so that the arranged RRSAD may be being programmed across the parallel sense units on memory device 110.

In some cases, controller 108 may identify the RRSAD based on a host hint included in the RRSAD. The host hint may be provided by the host sending the RRSAD. For example, controller 108 may identify RRSAD sent from host 102a (also referred to herein as a first host) using a RRSAD hint provided by host 102a. Thereafter, when controller programs data including RRSAD from one or more hosts 102, controller 108 may ensure that the RRSAD from each host 102. is spread across the parallel sense units of the meta block. Controller may ensure that the RRSAD data from, for example, the first host 102 is spread across parallel sense units by arranging the write commands cached in RAM 106. Controller 108 may then program the write commands in the parallel sense units in the arranged order to enable subsequent parallel read operations.

When programming data received from hosts 102, controller 108 may maintain information about where the last/previous RRSAD for, for example, host 102a, is written. Controller 108 may also aim to program consecutive RRSADs from host 102a in parallel sense units most of the time. If more than one host 102 is sending RRSAD, controller 108 may also keep track of each host 102 sending RRSAD and may aim to program consecutive RRSADs from each host 102 in parallel sense units most of the time. In some cases, controller 108 may delay executing one or more pending write commands to program consecutive RRSADs from for example, host 102a in parallel sense units, and thereby enable subsequent parallel reads.

Controller 108 may also program RRSAD on parallel sense units so that the RRSAD from, for example, host 102a may be distributed equally or close to equally across the parallel sense units at a die level. Consider an example where there is no more space on RAM 106 or where a power cycle is about to take place. Controller 108 may have to program the data currently in RAM 106 to an open meta block to preserve the data. Controller 108 may therefore not be able to rearrange the data currently in RAM 106 such that the RRSAD currently stored in RAM 106 for, for example, host 102a may be programmed across parallel sense units. Controller 108 may program the data store in RAM 106 such that RRSAD from host 102a may be localized on one or more sense units.

Controller 108 may monitor where the RRSAD for host 102a is stored. Over time controller 108 may ensure that the RRSAD for host 102a is distributed equally or close to equally at a die level. By distributing the RRSAD for a host equally or close to equally at the die level, controller 108 may enable subsequent high random read performance. In an example where multiple hosts 102 send read commands to storage device 104 and in cases where controller 108 distributes RRSAD for a host 102 equally or close to equally at the die level, there is an increased probability that controller 108 may select a set of read commands from pending read commands such that the selected read commands may be executed across parallel sense units, thus ensuring high random read performance on storage device 104.

In an implementation, a host 102 may rearrange the order of data sent to storage device 104 so that RRSAD from one or more hosts/applications 102 may be spread across the parallel sense units of the meta block based on the order of how the data is transmitted from host 102. Host 102 may determine the parallel sense units' capability of memory device 110 (for example, the number of dies and/or AIPR planes in the meta block). In some cases, host 102 may determine the parallel sense units present in memory device 110 by periodically querying storage device 104. In some cases, storage device 104 may trigger a communication to provide host 102 information relating to the parallel sense units present in memory device 110. Storage device 104 may notify host 102 of any changes in the parallel sense capability of the memory device for new write commands.

Upon determining the parallel sense capabilities of memory device 110, hosts 102 may ensure that write commands are sent in a way that RRSAD may be programmed in parallel sense units. In an implementation, hosts 102 may align host command formation with the parallel sense capabilities of memory device 110 to ensure that RRSAD is written to independent sense units in memory device 110. For example, when host 102a sends data to storage device 104, host 102a may ensure that various RRSAD fragments are transmitted to storage device 104 in a manner where the RRSAD may be stored in RAM 106 and subsequently programmed in parallel sense units based on the data formation and transmission order from host 102a.

In some cases, host 102 may form a command group to ensure that RRSAD is written to independent sense units in memory device 110. The command group may be an indication to storage device 104 to select write commands in a group provided by host 102 together. In some cases where host 102 cannot form a command group, the host may hold off sending the data to storage device 104 until host 102 can form the proper command group.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

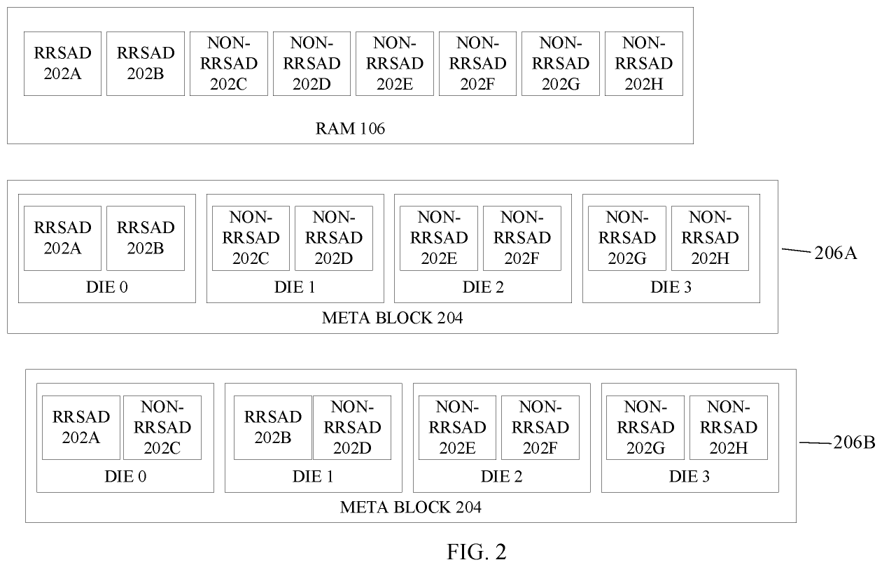

FIG. 2 is a block diagram showing an arrangement of pending write commands being programmed on an open meta block based on an RRSAD hint sent from a host in accordance with some implementations. A first host 102a may send RRSAD 202a and 202b to storage device 104 for the data to be programmed on memory device 110. RRSAD 202a and 202b may require higher read performance and may include an RRSAD hint sent from host 102a. A second host 102b may send non-RRSAD 202c-202h to storage device 104 for the data to be programmed on memory device 110. Memory device 110 may include a meta block 204 including blocks from die 0-die 3, wherein die 0-die 3 may be parallel sense units on memory device 110. Controller 108 may program one die page as a programming unit and each die 0-3 may be sequentially programmed to store two pages.

RAM 106 shows the order of the data received from host 102a and 102b by storage device. Once controller 108 receives sufficient data to program open meta block 204, if storage device stores the data in the order received, the data would be programmed in memory device, as shown in 206a. If storage device 104 later receives two read operations from host 102a at the same time, the read operations will be serialized as RRSAD 202a and 202b would be localized on die 0. Controller 108 may thus arrange the program order so that RRSAD 202a may be written to die 0 and RRSAD 202b may be written to die 1, as shown in 206b. After the data is programmed, if storage device 104 receives two sense operations from host 102a at the same time, controller 108 may execute the read operations in parallel as RRSAD 202a and 202b would spread across parallel sense units (i.e., dies 0-1). Using host hints provided by host 102a, controller 108 may thus rearrange the order in which data may be programmed on memory device 110. As indicated above FIG. 2 is provided as an example. Other examples may differ from what is described in FIG. 2.

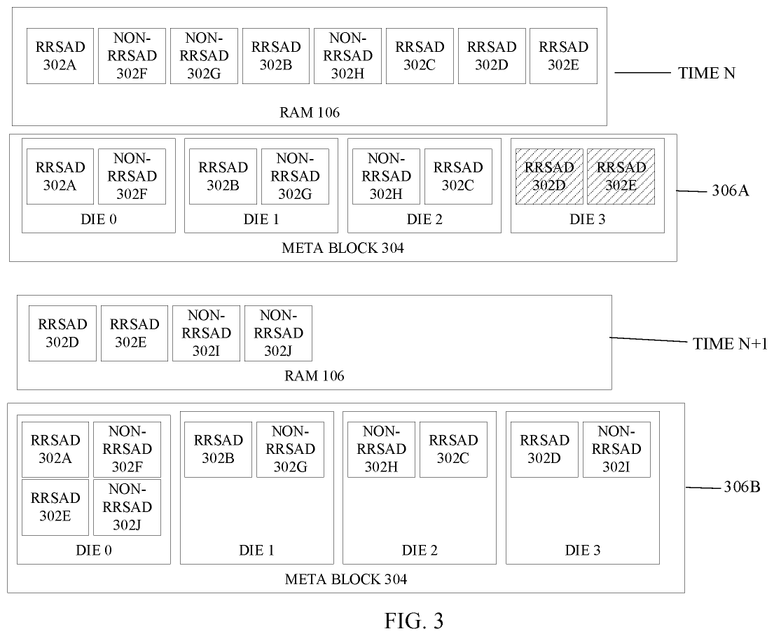

FIG. 3 is another block diagram showing an arrangement of pending write commands based on a RRSAD hint from a host in accordance with some implementations. Host 102a may send RRSAD 302a-302e to storage device 104 for the data to be programmed on memory device 110 and RRSAD 302a-302e may include a RRSAD hint. Host 102b may send non-RRSAD 302f-302h to storage device 104 to be programmed on memory device 110. Memory device 110 may include a meta block 304 including blocks from die 0-die 3, wherein die 0-die 3 may be parallel sense units on memory device 110. Controller 108 may program one die page as a programming unit and each die 0-3 may be sequentially programmed to store two pages.

RAM 106 shows the order in which the data may be received by storage device 104. If storage device stores the data in the order received, the data would be programmed in memory device, as shown in 306a. Even if controller 108 arranged the program command order so that RRSAD 302a-302e may be written to parallel sense units (i.e., dies 0-3), RRSAD 302d and 302e would be localized on die 3, as shown in 306a. If storage device 104 later receives two sense operations from host 102a at the same time to read RRSAD 302d and 302e, the read operations would be serialized as RRSAD 302d and 302e are localized on die 3. Controller 108 may thus determine that parallelism cannot be achieved for RRSAD 302d and 302e, if RRSAD 302d and 302e are programmed at the same time (referred to herein as a first programming time or time N) as the other data (i.e., RRSAD 302a-302c and non-RRSAD 302f-302h) currently in RAM 106. Block 306A thus shows lines across RRSAD 302d and 302e to indicate that they may not be programmed at time N. Controller 108 may delay programming RRSAD 302d and 302e until a subsequent time (referred to herein as a second programming time or time N+1.

When controller receives non-RRSAD 302i and 302j, controller 108 may cache non-RRSAD 302i and 302j in RAM 106, as shown at time N+1. Controller 108 may rearrange the order of the pending data in RAM 106, i.e., RRSAD 302d and 302e and non-RRSAD 302i and 302j and store the pending data in parallel sense units (i.e., dies 3 and 1), as shown in 306b. Controller 108 may thus delay one or more write commands to enable subsequent parallel read operations. As indicated above FIG. 3 is provided as an example. Other examples may differ from what is described in FIG. 3.

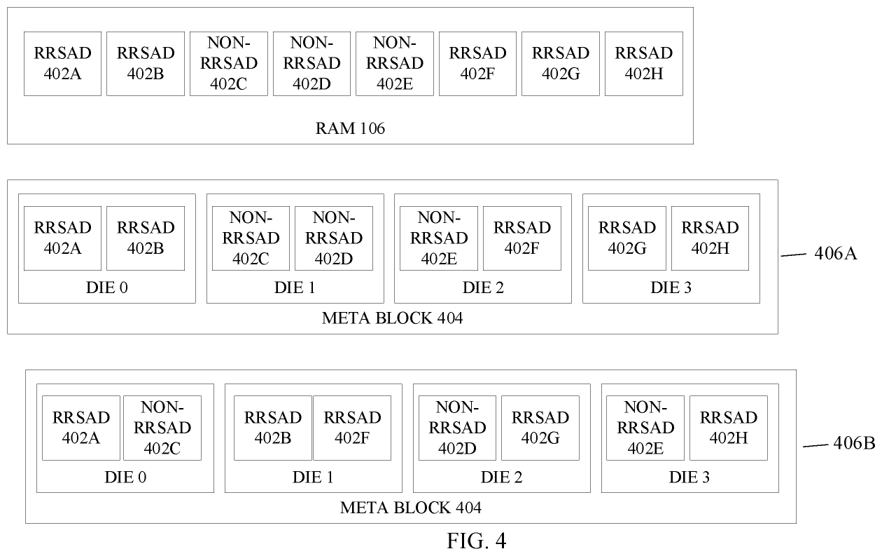

FIG. 4 is a block diagram showing an arrangement of pending write commands based on RRSAD hints from multiple hosts in accordance with some implementations. Host 102 may send RRSAD 402a-402b, host 102b may send non-RRSAD 402c-402e, and host 102c may send RRSAD 402f-402h to storage device 104 for the data to be programmed on memory device 110. RRSAD 402a-402b may include a RRSAD hint sent from host 102a and RRSAD 402f-402h may include a RRSAD hint sent from host 102c. Memory device 110 may include a meta block 404 including blocks from die 0-die 3, wherein die 0-die 3 may be parallel sense units on memory device 110. Controller 108 may program one die page as a programming unit and each die 0-3 may be sequentially programmed to store two pages.

RAM 106 shows the order in which the data may be received by storage device 104. If storage device stores the data in the order received, the data would be programmed in memory device, as shown in 406a. Controller 108 may rearrange the program command order so that data pending in RAM 106 may be written to parallel sense units (i.e., dies 0-3), as shown in 406b. As indicated above FIG. 4 is provided as an example. Other examples may differ from what is described in FIG. 4.

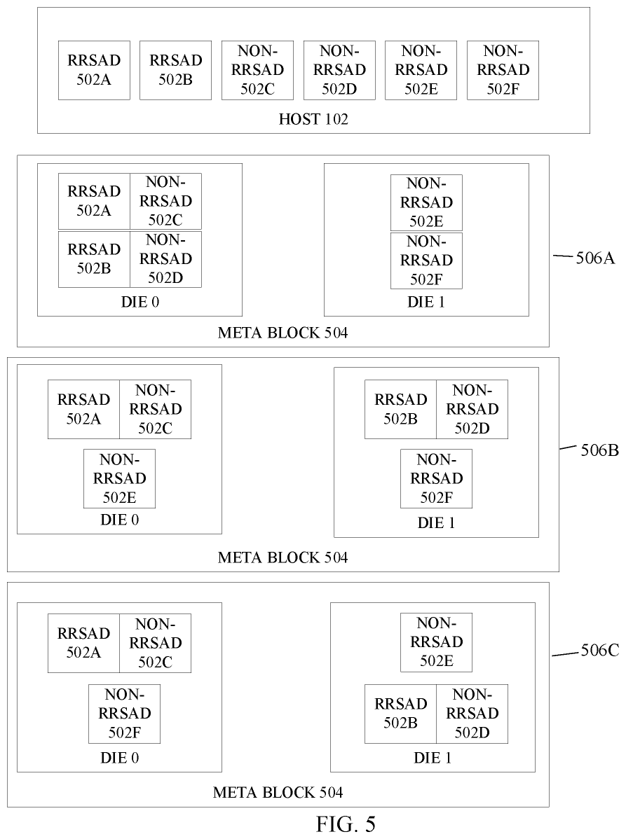

FIG. 5 is a block diagram showing an arrangement of write commands at a host to ensure that RRSAD is spread across parallel sense units in accordance with some implementations. Host 102a may send RRSAD 502a-502b from a first application, non-RRSAD 502c-502d from a second application, and non-RRSAD 502e-502f from a third application. The commands with RRSAD 502a-502b may be 4K, the commands with non-RRSAD 502c-502d may be 60K, and the command with non-RRSAD 502e-502f may be 64K. Host 102 may also determine that the programming size/page is, for example, 64K and host 102 may send commands to program a page at a time. If host 102 sends the RRSAD and non-RRSAD commands to storage device in 64K fragments in the order in which the commands were generated, controller 108 may store the commands in meta block 504 including dies 0 and 1, as shown in 506a.

Prior to sending the data to storage device 104, host 102 may determine how many parallel sense units are present in memory device 110 (for example, the number of dies and/or AIPR planes in meta block 504). Hosts 102 may determine the parallel sense units present in memory device 110 by periodically querying storage device 104. In some cases, storage device 104 may trigger a communication to provide host 102 information relating to the parallel sense units present in memory device 110. Upon determining the parallel sense capabilities of memory device 110, hosts 102 may align host command formation with the parallel sense capabilities of memory device 110 to ensure that RRSAD may be written to independent sense units in memory device 110. In some cases, host 102 may group the write commands and send grouped commands in a manner for RRSAD to be programmed in parallel sense units, as shown in 506b.

In some cases, host 102 may hold commands for a period unit an opportunity arises to group commands. For example, if host generates RRSAD 502a-502b, each or which is 4K; then non-RRSAD 502c which is 60K; then non-RRSAD 502e-502f, each of which is 64K; and non-RRSAD 502d which is 60K, in forming commands to be sent to storage device 104, host may group RRSAD 502a and non-RRSAD 502c to form a 64K command and send that command to storage device 104. Host 102 may send non-RRSAD 502e as a 64K command and non-RRSAD 502f as a 64K command. Host 102 may hold RRSAD 502b until it generates non-RRSAD 502d and may form a 64K command with RRSAD 502b and RRSAD 502d, as shown in 506c. When host 102a sends data to storage device 104, host 102a may ensure that various RRSAD fragments are transmitted to storage device 104 in a manner where the RRSAD may be stored in RAM 106 and subsequently programmed on parallel sense units. As indicated above. FIG. 5 is provided as an example. Other examples may differ from what is described in FIG. 5.

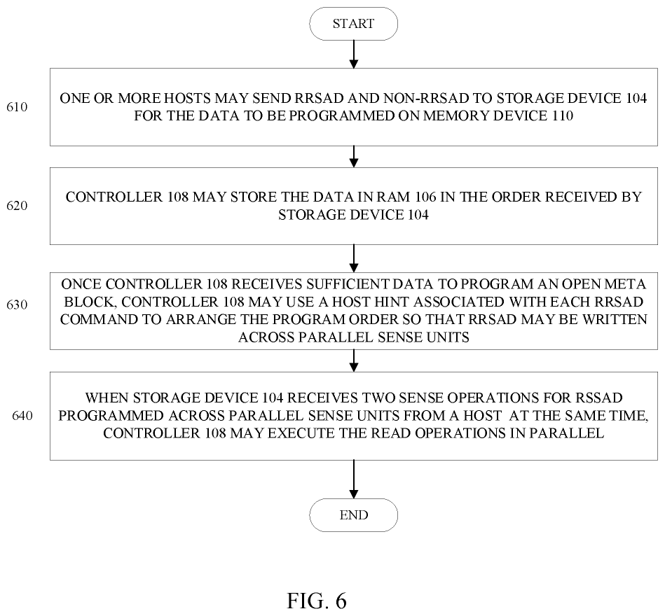

FIG. 6 is a flow diagram of an example process for rearranging pending write commands being programmed on an open meta block based on a RRSAD hint sent from one or more hosts in accordance with some implementations. At 610, one or more hosts may send RRSAD and non-RRSAD to storage device 104 for the data to be programmed on memory device 110. At 620, controller 108 may store the data in RAM 106 in the order received by storage device 104. At 630, once controller 108 receives sufficient data to program an open meta block, controller 108 may use a host hint associated with each RRSAD command to rearrange the program order so that RRSAD may be written across parallel sense units. At 640, when storage device 104 receives two sense operations for RSSAD programmed across parallel sense units from a host at the same time, controller 108 may execute the read operations in parallel. As indicated above FIG. 6 is provided as an example. Other examples may differ from what is described in FIG. 6.

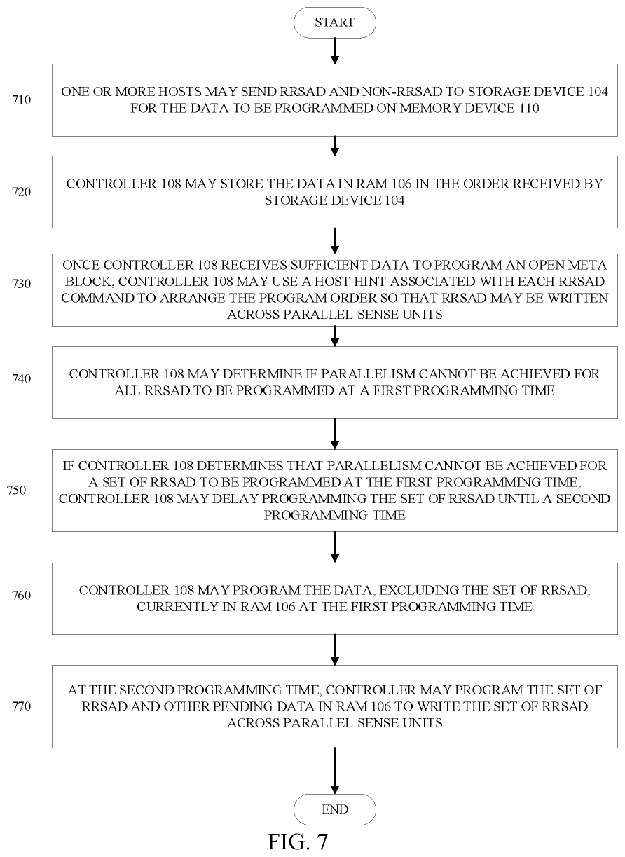

FIG. 7 is another flow diagram of an example process for rearranging pending write commands based on a RRSAD hint from a host in accordance with some implementations. At 710, one or more hosts may send RRSAD and non-RRSAD to storage device 104 for the data to be programmed on memory device 110. At 720, controller 108 may store the data in RAM 106 in the order received by storage device 104. At 730, once controller 108 receives sufficient data to program an open meta block, controller 108 may use a host hint associated with each RRSAD command to arrange the program order so that RRSAD may be written across parallel sense units. At 740, controller 108 may determine if parallelism cannot be achieved for all RRSAD to be programmed at a first programming time.

At 750, if controller 108 determines that parallelism cannot be achieved for a set of RRSAD to be programmed at the first programming time, controller 108 may delay programming the set of RRSAD until a second programming time. At 760, controller 108 may program the data, excluding the set of RRSAD, currently in RAM 106 at the first programming time. At 770, at the second programming time, controller may program the set of RRSAD and other pending data in RAM 106 to write the set of RRSAD across parallel sense units. As indicated above FIG. 7 is provided as an example. Other examples may differ from what is described in FIG. 7.

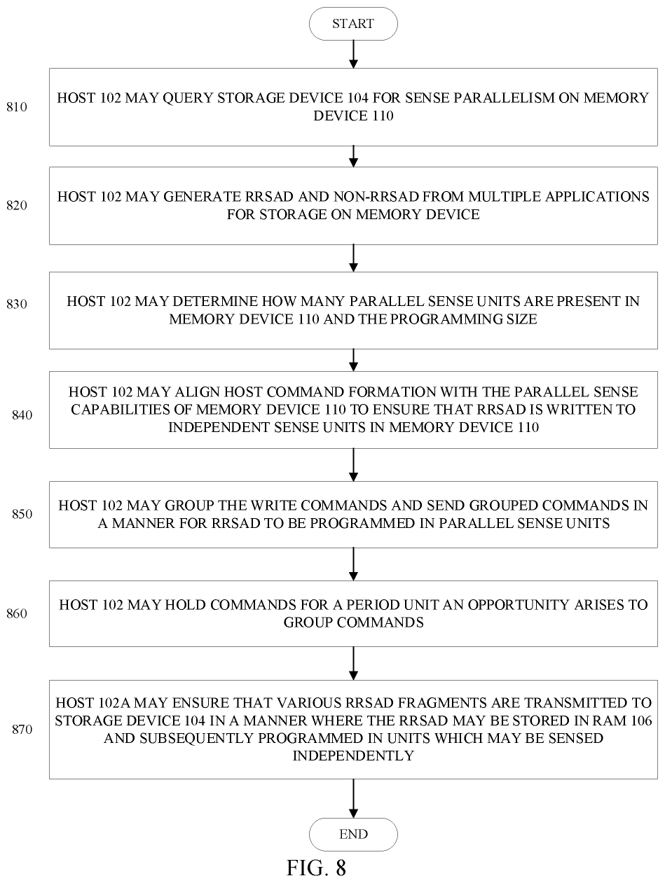

FIG. 8 is a flow diagram of an example process for rearranging write commands at a host to ensure that RRSAD is spread across parallel sense units in accordance with some implementations. At 810, host 102 may query storage device 104 for sense parallelism on memory device 110. At 820, host 102 may generate RRSAD and non-RRSAD from multiple applications for storage on memory device. At 830, host 102 may determine how many parallel sense units are present in memory device 110 and the programming size. At 840, host 102 may align host command formation with the parallel sense capabilities of memory device 110 to ensure that RRSAD is written to independent sense units in memory device 110. At 850, host 102 may group the write commands and send grouped commands in a manner for RRSAD to be programmed in parallel sense units. At 860, host 102 may hold commands for a period unit an opportunity arises to group commands. At 870, host 102a may ensure that various RRSAD fragments are transmitted to storage device 104 in a manner where the RRSAD may be stored in RAM 106 and subsequently programmed in units which may be sensed independently. As indicated above. FIG. 8 is provided as an example. Other examples may differ from what is described in FIG. 8.

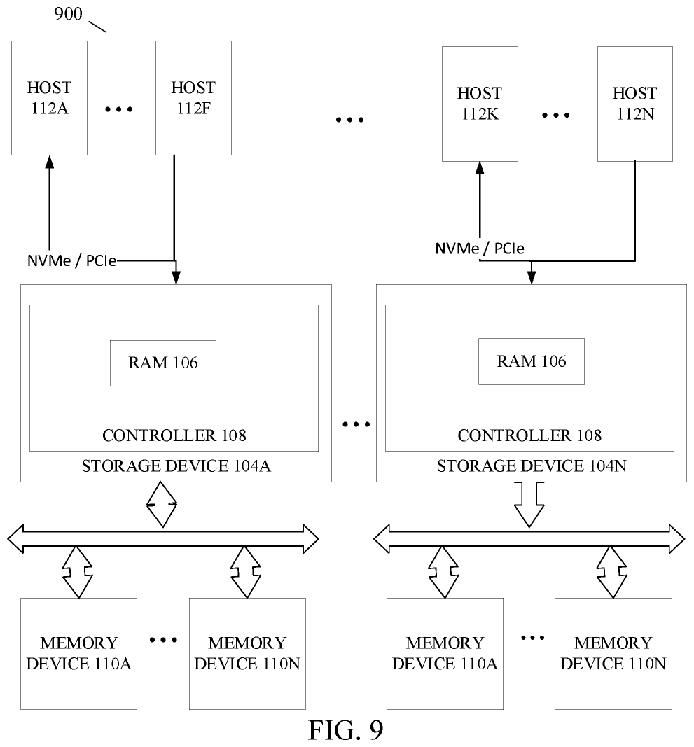

FIG. 9 is a diagram of an example environment in which systems and/or methods described herein are implemented. As shown in FIG. 9, Environment 900 may include hosts 102-102n (referred to herein as host(s) 102), and one or more storage devices 104a-104n (referred to herein as storage device(s) 104). Storage device 104 may include a controller 108 to arrange pending write commands being programmed on an open meta block based on a RRSAD hint sent from one or more hosts. Hosts 102 and storage devices 104 may communicate via Non-Volatile Memory Express (NVMe) over peripheral component interconnect express (PCI Express or PCIe), or the like.

Devices of Environment 900 may interconnect via wired connections, wireless connections, or a combination of wired and wireless connections. For example, the network in FIG. 9 may include NVMe over Fabric (NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 9 are provided as an example. In practice, there may be additional devices and/or networks, fewer devices and/or networks, different devices and/or networks, or differently arranged devices and/or networks than those shown in FIG. 9. Furthermore, two or more devices shown in FIG. 9 may be implemented within a single device, or a single device shown in FIG. 9 may be implemented as multiple, distributed devices. Additionally, or alternatively, a set of devices (e.g., one or more devices) of Environment 900 may perform one or more functions described as being performed by another set of devices of Environment 900.

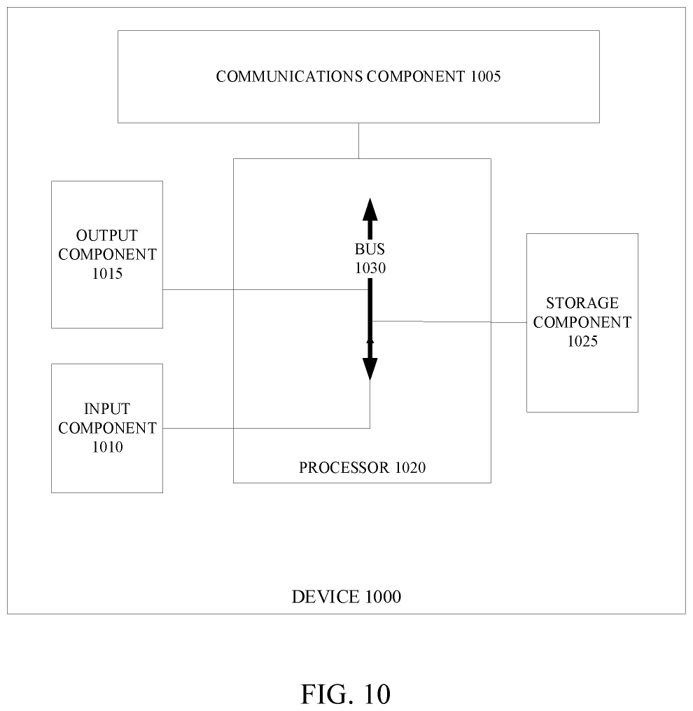

FIG. 10 is a diagram of example components of one or more devices of FIG. 1. In some implementations, host 102 may include one or more devices 1000 and/or one or more components of device 1000. Device 1000 may include, for example, a communications component 1005, an input component 1010, an output component 1015, a processor 1020, a storage component 1025, and a bus 1030. Bus 1030 may include components that enable communication among multiple components of device 1000, wherein components of device 1000 may be coupled to be in communication with other components of device 1000 via bus 1030.

Input component 1010 may include components that permit device 1000 to receive information via user input (e.g., keypad, a keyboard, a mouse, a pointing device, and a network/data connection port, or the like), and/or components that permit device 1000 to determine the location or other sensor information (e.g., an accelerometer, a gyroscope, an actuator, another type of positional or environmental sensor). Output component 1015 may include components that provide output information from device 1000 (e.g., a speaker, display screen, and network/data connection port, or the like). Input component 1010 and output component 1015 may also be coupled to be in communication with processor 1020.

Processor 1020 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1020 may include one or more processors capable of being programmed to perform a function. Processor 1020 may be implemented in hardware, firmware, and/or a combination of hardware and software.

Storage component 1025 may include one or more memory devices, such as random-access memory (RAM) 106, read-only memory (ROM), and/or another type of dynamic or static storage device (e.g., a flash memory, a magnetic memory, and/or optical memory) that stores information and/or instructions for use by processor 1020. A memory device may include memory space within a single physical storage device or memory space spread across multiple physical storage devices. Storage component 1025 may also store information and/or software related to the operation and use of device 1000. For example, storage component 1025 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 1005 may include a transceiver-like component that enables device 1000 to communicate with other devices, such as via a wired connection, a wireless connection, or a combination of wired and wireless connections. The communications component 1005 may permit device 1000 to receive information from another device and/or provide information to another device. For example, communications component 1005 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 1005 may also include one or more broadband and/or narrowband transceivers and/or other similar types of wireless transceiver configurable to communicate via a wireless network for infrastructure communications. Communications component 1005 may also include one or more local area network or personal area network transceivers, such as a Wi-Fi transceiver or a Bluetooth transceiver.

Device 1000 may perform one or more processes described herein. For example, device 1000 may perform these processes based on processor 1020 executing software instructions stored by a non-transitory computer-readable medium, such as storage component 1025. As used herein, the term “computer-readable medium” refers to a non-transitory memory device. Software instructions may be read into storage component 1025 from another computer-readable medium or from another device via communications component 1005. When executed, software instructions stored in storage component 1025 may cause processor 1020 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 10 are provided as an example. In practice, device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

1. A storage device to minimize localization of random read sensitive application data (RRSAD) on a memory device, the storage device comprises:
a memory device including parallel sense units;
a random-access memory to store data received from hosts; and
a controller to receive the data from the hosts, cache the data in the random-access memory, identify RRSAD, including data from different non-contiguous logical block address ranges, received from a first host in cached data, arrange a storage order of the data, and program the RRSAD from the first host across the parallel sense units on the memory device according to an arranged storage order.

2. The storage device of claim 1, wherein the controller identifies the RRSAD based on a host hint included in the RRSAD, wherein the host hint is provided by the first host.

3. The storage device of claim 1, wherein when programming the RRSAD, the controller maintains information about where a last RRSAD for the first host is written.

4. The storage device of claim 1, wherein when programming the RRSAD, the controller programs consecutive RRSADs from the first host in parallel sense units most of the time.

5. The storage device of claim 1, wherein the controller delays executing at least one pending write command to program consecutive RRSADs from the first host in parallel sense units.

6. The storage device of claim 1, wherein the RRSAD from the first host is distributed equally across the parallel sense units at a die level.

7. The storage device of claim 1, wherein a parallel read capability on the memory device is at least one of a die level and a plane level.

8. The storage device of claim 1, wherein the memory device supports an asynchronous independent plane read feature, wherein a plane is read independently and is an independent sense unit.

9. The storage device of claim 1, wherein the hosts include applications and virtual machines.

10. A storage device to minimize localization of random read sensitive application data (RRSAD) on a memory device, the storage device comprises:
a memory device including parallel sense units;
a random-access memory to store data received from a host; and
a controller to provide a parallel sense capability of the memory device to the host; to receive the data from the host formed according to the parallel sense capability of the memory device, and program the RRSAD, including data from different non-contiguous logical block address ranges, received from the host across the parallel sense units on the memory device according to an order received from the host.

11. The storage device of claim 10, wherein the controller provides the parallel sense capability of the memory device in response to a query from the host.

12. The storage device of claim 10, wherein the controller provides the parallel sense capability of the memory device to the host by triggering a communication with the host.

13. The storage device of claim 10, wherein the controller notifies the host of any changes in the parallel sense capability of the memory device.

14. The storage device of claim 10, wherein the controller programs the data in groups provided by the host.

15. A method on a storage device for minimizing localization of random read sensitive application data (RRSAD) on a memory device, the storage device comprises controller to execute the method including:
receiving data from hosts;
caching the data in a random-access memory;
identifying RRSAD received from a first host in cached data, the RRSAD, including data from different non-contiguous logical block address ranges, received from the first host;
arranging a storage order of the data; and
programming the RRSAD across parallel sense units on a memory device according to an arranged storage order.

16. The method of claim 15, further comprising identifying the RRSAD based on a host hint included in the RRSAD, wherein the host hint is provided by the first host.

17. The method of claim 15, wherein when programming the RRSAD, the method further comprises maintaining information about where a last RRSAD for the first host is written.

18. The method of claim 15, further comprising programming consecutive RRSADs from the first host in parallel sense units most of the time.

19. The method of claim 15, further comprising delaying programming of at least one pending write command to program consecutive RRSADs from the first host in parallel sense units.

20. The method of claim 15, further comprising distributing RRSAD from the first host equally across the parallel sense units at a die level.
